(19) United States
(12) Patent Application Publication
(10) Pub. No.: US 2015/0264513 A1
(43) Pub. Date: Sep. 17, 2015

(54) USB AUDIO AND POWER TRANSMISSION

(71) Applicant: GOOGLE INC., Mountain View, CA (US)

(72) Inventor: Sergey Ryazanov, St. Petersburg (RU)

(21) Appl. No.: 14/434,367

(22) PCT Filed: Oct. 9, 2012
(86) PCT No.: PCT/RU2012/000820

§ 371 Date: Apr. 8, 2015

(51) Int. Cl. H04W 4/00; G06F 13/38; G06F 13/42

(52) U.S. Cl. CPC H04W 4/008; G06F 13/4221; G06F 13/387

(57) ABSTRACT

In general, aspects of the present disclosure may be directed to techniques for streaming audio over, and receiving power from a Universal Serial Bus interface. In an example, a device includes at least one processor, an audio module operable by the at least one processor to generate digital audio data stream based on audio data stored at the device, convert the digital audio stream into an audio format compatible with output by a Universal Serial Bus interface, and output the digital audio data stream to a Universal Serial Bus host using a Universal Serial Bus microphone interface, wherein the device and the Universal Serial Bus host are coupled by a Universal Serial Bus connection.

### BACKGROUND

Users may connect a mobile computing device (e.g., a smartphone) and listen to music stored on or received by the mobile phone through an external audio connection (e.g., automobile speakers). For example, a user may connect a mobile computing to a power supply and external speakers by using two separate cables because mobile computing devices may have separate jacks for outputting audio receiving power. A user may connect a Universal Serial Bus (USB) cable (e.g., a micro USB cable) to supply power to the mobile computing device from the power source, and a separate audio cable (e.g., a tip/ring/sleeve (TRS) cable) to transmit audio from the mobile computing device to the external speakers.

### SUMMARY

In one example, a method may include generating, by a computing device, a digital audio data stream based on audio data stored at the computing device, converting, by the computing device, the digital audio streams into an audio format compatible with output by a Universal Serial Bus (USB) interface, and outputting, by the computing device, the digital audio data streams to a Universal Serial Bus (USB) host using a USB microphone interface, wherein the computing device and the USB host are coupled by a USB connection.

In another example, a computer-readable medium encoded with (or storing instructions) that, when executed by at least one programmable processor of a computing device, may cause the at least one programmable processor to perform operations. The operations may include generating, a digital audio data stream based on audio data stored at the computing device. The operations may further include converting the digital audio stream into an audio format compatible with output by a Universal Serial Bus (USB) interface. The operations may further include outputting the digital audio data stream to a Universal Serial Bus (USB) host using a USB microphone interface, wherein the computing device and the USB host are coupled by a USB connection.

In another example, a device may include at least one processor and an audio module operable by the at least one processor. The audio module may be operable by the at least one processor to generate digital audio data streams based on audio data stored at the device, convert the digital audio streams into an audio format compatible with output by a Universal Serial Bus (USB) interface, and output the digital audio data streams to a Universal Serial Bus (USB) host using a USB microphone interface, wherein the device and the USB host are coupled by a USB connection.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example of a mobile computing device configured to transmit USB audio to, and receive power from, a USB host in accordance with one or more aspects of the present disclosure.

FIG. 2 is a block diagram illustrating an example mobile computing device that is configured to act as a USB class audio device in accordance with one or more aspects of the present disclosure.

FIG. 3 is a conceptual diagram illustrating an example of a USB microphone logical topology in accordance with one or more aspects of the present disclosure.

FIG. 4 is a diagram illustrating a hierarchy of descriptors of a USB microphone interface in accordance with one or more aspects of the present disclosure.

FIG. 5 is a diagram illustrating a hierarchy of AudioStreaming interface sub-descriptors of a USB microphone interface in accordance with one or more aspects of the present disclosure.

FIG. 6 is a diagram illustrating a hierarchy of AudioControl interface sub-descriptors of a USB microphone interface in accordance with one or more aspects of the present disclosure.

FIG. 7 is a conceptual diagram illustrating a series of USB transfers between a USB host and a USB device in accordance with one or more aspects of the present disclosure.

FIG. 8 is a flowchart illustrating an example process of transmitting audio to, and receiving power from a mobile computing device in accordance with one or more aspects of the present disclosure.

### DETAILED DESCRIPTION

In general, this disclosure is directed to techniques for enabling a mobile computing device (e.g., a smartphone) to transmit audio to an external audio device, such as an audio head unit or receiver, and to receive power from the external device using a single cable. Currently, a user may connect his or her mobile computing device to a power supply and an external audio device by using two separate cables because the mobile computing device may have separate jacks or ports for audio output and power transmission. For example, the mobile computing device may receive power from a Universal Serial Bus (USB) cable (e.g., micro USB cable), and the mobile computing device may use an audio cable (e.g., tip/ring/sleeve (TRS) cable) to transmit audio from the mobile device to an external audio device.

Techniques of the present disclosure enable a mobile computing device to receive power and output audio to an external audio device using a single USB cable. In one example, a user may select a logical audio interface device mode (e.g., a USB microphone interface) of the mobile device when the mobile device is connected over a USB connection (e.g., a USB cable). The logical audio interface may change how a USB host perceives the mobile device. In one example, when a user selects the logical audio interface device mode, the computing device may generate a digital audio data stream based on stored audio data of the mobile computing device and output the digital audio data streams to the external audio device (e.g., a USB host device). In other words, the mobile computing device may appear to the USB host as though the mobile computing device is a USB microphone, and the data transmitted over the USB connection may appear to the USB host as though it is audio captured by a microphone, even though the audio transmitted via the USB connection is stored locally on the mobile computing device.

In this way, the mobile computing device operates not as a mass storage device, like a USB flash drive or other USB storage device, but rather as a USB microphone device. The mobile computing device may transfer the digital audio data streams from the mobile computing device to the USB host using the USB microphone interface defined in the USB Audio Device Class 1.0 or 2.0 specifications. The USB host may receive the digital audio stream from the mobile computing device and convert the digital audio stream to an analog signal and output the analog audio signal to speakers of the USB host. Additionally, the USB connection may supply power from the USB host to the mobile computing device when the mobile computing device is configured in the USB microphone mode.

In another example, Near Field Communication (NFC) technology may cause the mobile computing device to be configured as a USB microphone device. For example, if the mobile computing device detects an NFC label, and the mobile computing device detects a USB host, the mobile computing device may determine that the mobile computing device is connected to an audio head unit of a vehicle. The mobile computing device may further determine that the USB host may provide power, and the mobile computing device may configure itself to receive power over the USB connection. In this instance, the computing device may switch into the logical audio interface device mode automatically and not require a user to manually select the logical audio interface device mode.

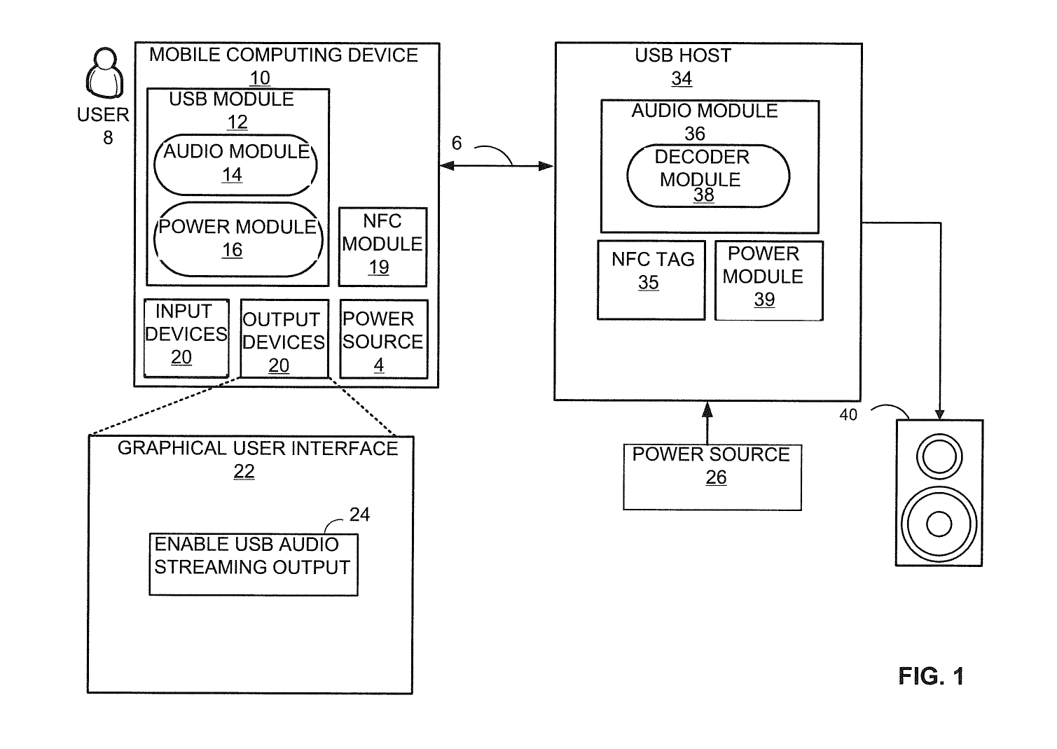

FIG. 1 is a conceptual diagram illustrating an example of a mobile computing device that is configured to transmit USB audio to, and receive power from, a USB host in accordance with one or more aspects of the present disclosure. In the example of FIG. 1, computing mobile computing device 10 is connected to USB host 34 via USB connection 6. USB connection 6 may enable the transmission of data and/or power between computing device 10 and USB host 34. In some examples, USB connection 6 may comprise a USB cable such as a standard USB cable, micro, or mini USB cable.

Mobile computing device 10 may generally comprise a device such as a tablet, net book, laptop, smartphone, or another mobile computing device, or any other device capable of being configured as a USB microphone interface, and which is able to stream audio stored on mobile computing device 10 via USB connection 6 in accordance with one or more aspects of this disclosure. Mobile computing device 10 may include a power source 4, USB module 12, input devices 18, NFC module 19, and output devices 20.

In general, USB module 12 may perform operations necessary to support communication between mobile computing device 10 and one or more USB devices over USB connection 6. The USB Audio device class specification defines a number of standard implementations and specifications (referred to as “USB audio device class specifications”) that define requirements for USB-compliant audio devices, such as microphones, and headphones. There are two versions of the USB audio standard document that define the USB audio device class specifications. The first version of the USB audio standard is titled “Universal Serial Bus Audio Device Class Specification for Basic Audio Devices, Release 1.0,” (referred to as “USB Audio 1.0 Standard”) by the USB Implementers Forum, published Nov. 24, 2009, the entirety of which is incorporated herein by reference. The USB Implementers Forum also released a subsequent version of the USB audio device class specification for high speed (e.g., USB 2.0) devices, titled “Universal Serial Bus Device Class Definition for Audio Devices, Release 2.0,” (referred to as “USB Audio 2.0 Standard”) published May 31, 2006, the entirety of which is also incorporated herein by reference.

USB module 12 may also include audio module 14, and power module 16. Audio module 14 may format of audio data stored on mobile computing device 10, such as on a flash memory or a hard disk of mobile computing device 10, for transmission or streaming to USB host 34 over USB connection 6. In some examples, audio module 14 may convert between formats of audio data stored on mobile computing device 10 and audio formats supported by USB module 12 and USB connection 6.

Power module 16 may receive power from USB host 34 over USB connection 6, for example using one or more wires of USB connection 6 that may be dedicated to transmitting power over. Power module 16 may perform techniques such as voltage and current regulation, as well as voltage transformation in order to convert the power received over USB connection 6 to power mobile computing device 10. In some examples, power module 16 may utilize the received power from USB host 34 as the sole power source for mobile computing device 10, or to charge power source 4 (e.g., a battery) of mobile computing device 10.

Power module 16 may control the power transfer from USB host 34 over USB connection 6 in accordance with the USB power transmission standard, as defined in the document titled Universal Serial Bus Power Delivery Specification Revision 1.0 (“USB Power Standard”), published 5 Jul. 2012 by the USB Implementers Forum, and which is herein incorporated by reference in its entirety. In particular, mobile computing device 10 may receive power over one of the four pins of a USB cable, referred to as “V_{BUS}.” The V_{BUS} pin may provide up to 100 ma (milliamps) of current from a USB host, such as USB host 34, for so-called “low power devices,” and up to 500 ma of current for so-called “high power devices.” If mobile computing device 10 is configured as a USB 3.0 device, mobile computing device 10 may receive as much as 100 W of power from USB host 34 over USB connection 6. According to the USB Audio Device Class 1.0 specification, for a device, such as mobile computing device 10, to be compliant with the USB Audio Device Class 1.0 standard, a compliant device must be a low power devices, i.e., may consume no more than 100 ma of current from V_{BUS}. Accordingly, if mobile computing device 10 is configured as a USB audio 1.0 device, as defined by the corresponding USB Audio 1.0 standard, mobile computing device 10 may be configured to consume no more than 100 ma.

Input devices 18 of mobile computing device 10 may include keyboards, pointing devices, microphones, and cameras capable of recording one or more images or video. Client devices 10 and 46 may also include one or more output devices, e.g., output device 20 of client device 10. Examples of output device 20 may include a video graphics card, computer display, sound card, and/or speakers. Mobile computing device 10 may include devices, such as presence-sensitive screens, which may comprise one or more of input devices 18 and output devices 20 into the same device.

Output devices 20 may include one or more displays (e.g., a presence-sensitive screen), which may output or display a graphical user interface (GUI 22). GUI 22 may include a user-selectable element 24. Responsive to receiving a selection of graphical element 24, USB module 12 may configure mobile computing device 10 to act as a USB audio device, such as a USB microphone. Responsive to the selection of user-selectable element 24, USB module 12 may also redirect any audio that is currently being output by mobile computing device 10 (e.g. audio output via speakers of mobile computing device 10) over USB connection 6.

USB host 34 may generally comprise any computing device that may be configured to act as a USB host. In some examples, USB host 34 may comprise an audio receiver, head unit of an automobile sound system, laptop, desktop, tablet, netbook, audio dock, or any other USB host computing device that is capable of receiving USB audio from a mobile computing device configured to act as a USB audio class device, such as a USB microphone.

USB host 34 may include an audio module 36. Audio module 36 may receive audio from mobile computing device 10 over USB connection 6. Audio module 36 may also convert the digital audio received from mobile computing device 10 to an analog signal. Audio module 36 may output the analog audio signal to one or more analog audio devices, such as speakers 28. Audio module 36 may receive audio in an encoded audio format, such as Motion Picture Experts Group Layer 3 (MP3), Windows Media Audio (WMA), or another encoded audio format, from USB module 12. In some examples, decoder module 38 may decode or decompress the encoded audio stream received over USB connection 6 such that audio module 36 may output the decoded digital signal as an analog signal, for example using one or more digital to analog converters (DACs). After receiving and possibly decoding the audio from mobile computing device 10, audio module 36 may output the audio to speakers 40, or another audio output device.

USB host 34 may also include a power module 39. Power module 39 may receive and regulate power from power source 26. Power module 36 may also transmit the power received from power source 26 to mobile computing device 10 over USB connection 6 in accordance with the USB standard, as described above with respect to power module 16. Power source 26 may comprise a battery, electrical outlet connection, or any other power source capable of powering USB host 34. Although illustrated as being separate from USB host 34, power source 26 may also be integrated within USB host 34 (e.g., a battery of a laptop or mobile computing device). Power module 39 may include one or more voltage and/or current regulators, and voltage transformers that allow USB host 34 to convert the power received from power source 26 into an appropriate voltage, current, and/or impedance for transmission to mobile computing device 10 over USB connection 6.

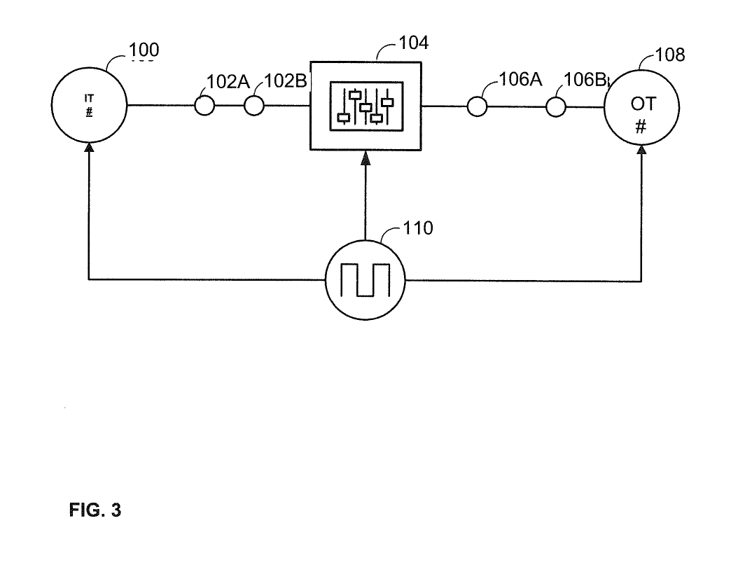

In response to connecting computing device 10 to USB host 34, USB module 12 may receive a setup message from USB host 34. In response to receiving the setup message, if mobile computing device 10 is configured to act as a USB microphone, USB module 12 may respond with one or more messages that may cause mobile computing device 10 to appear to USB host 34 as though mobile computing device 10 is a USB audio class device, such as USB microphone. The messages exchanged between USB host 34 and mobile computing device 10 are described in further detail below with respect to FIG. 3.

After completing the USB setup process, USB module 12 may configure mobile computing device 10 to redirect some or all audio streams from one or more of output devices 20 to USB module 12, similar to the process described above with respect to user 8 selecting graphical element 24 of GUI 22. USB module 12 may then transmit the received audio stream over USB connection 6 to USB host 34.

In some examples, mobile computing device 10 may include an NFC module 19. NFC module 19 may detect the presence of NFC tag 35, for example from USB host 34. Responsive to detecting a particular NFC tag, such as an NFC tag associated with USB host 34, mobile computing device 10 may configure mobile computing device 10 to redirect one or more audio streams from one or more of output devices 20 to USB module 12. USB module 12 may receive the one or more audio streams from mobile computing device 10, and transmit the streams to USB host 34 over USB connection 6.

USB host 34 may include an NFC module that is similar to NFC module 19 of mobile computing device 10. In other examples, NFC tag 35 may store identification information that uniquely identifies USB host 34. In some examples, USB tag 35 may be attached to or a part of USB host 34. In other examples, NFC tag 35 may be not be attached to or otherwise be physically separate from USB host 34.

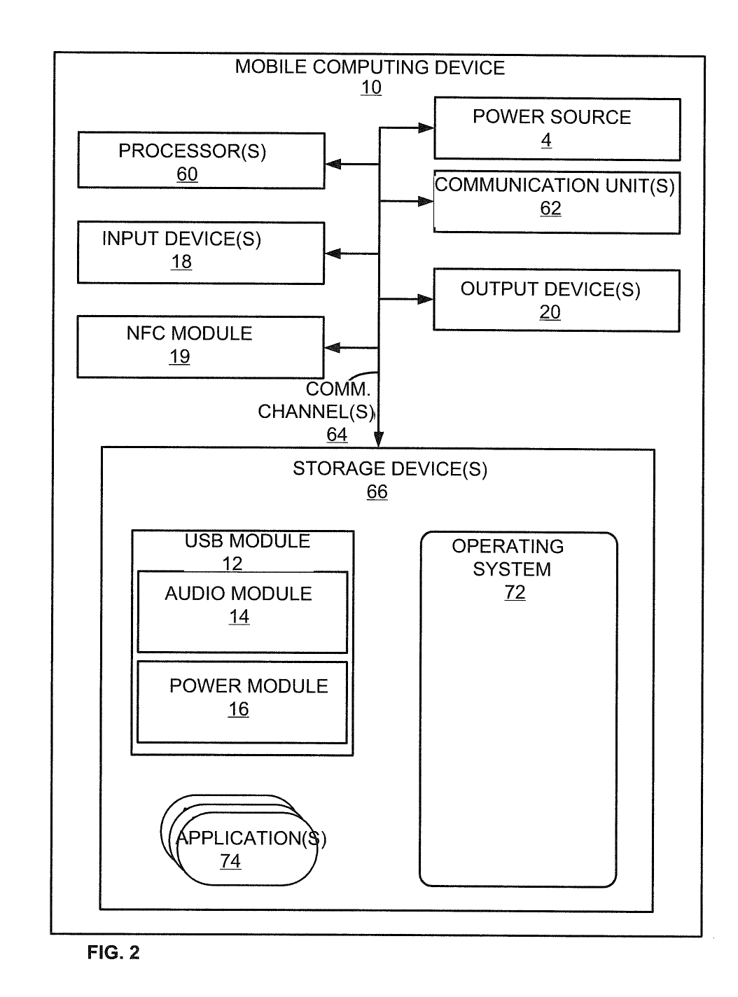

FIG. 2 is a block diagram of a mobile computing device that is configured to act as a USB audio device in accordance with one or more aspects of the present disclosure. FIG. 2 illustrates only one particular example of mobile computing device 10, and many other examples of mobile computing device 10 may be used in other instances. As shown in the specific example of FIG. 2, mobile computing device 10 includes one or more processors 60, one or more communication units 62, one or more storage devices 66, input devices 18, output devices 20, and power source 4. Mobile computing device 10 also includes an operating system 72 and applications 74 that are executable by mobile computing device 10. Each of components 4, 18, 19, 20, 60, 66, 74, and 72 may be interconnected (physically, communicatively, and/or operatively) for inter-component communications. In some examples, communication channels 64 may include a system bus, network connection, interprocess communication data structure, or any other channel for communicating data. As one example in FIG. 2, components 4, 18, 19, 60, 62, 66, 68, 70 and 74 may be coupled by one or more communication channels 64.

Processors 60, in one example, are configured to implement functionality and/or process instructions for execution within mobile computing device 10. For example, processors 60 may be capable of processing instructions stored in storage devices 66.

One or more storage devices 66, in one example, are configured to store information within mobile computing device 10 during operation. Storage devices 66, in some examples, are described as a computer-readable storage medium. In some examples, storage devices 66 are a temporary memory, meaning that a primary purpose of storage devices 66 is not long-term storage. Storage device 46, in some examples, is described as a volatile memory, meaning that storage devices 66 do not maintain stored contents when the computer is turned off. Examples of volatile memories include random access memories (RAM), dynamic random access memories (DRAM), static random access memories (SRAM), and other forms of volatile memories known in the art. Storage devices 66, in some examples, also include one or more computer-readable storage media. Storage devices 66 may be configured to store larger amounts of information than volatile memory. Storage devices 66 may further be configured for long-term storage of information. In some examples, storage devices 66 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

In some examples, storage devices 66 are used to store program instructions for execution by processors 60. Storage devices 66, in one example, are used by software or applications running on mobile computing device 10 (e.g., applications 70) to temporarily store information during program execution. In an example, storage device 66 may also be used to store audio data that mobile computing device 10 may transmit over a USB connection, such as USB connection 6 of FIG. 1. In some examples, the stored audio data may comprise compressed audio files, such as MP3 files, or any other audio format that is compatible with transmission over USB connection 6.

Storage devices 66 may include USB module 12. USB module 12 may comprise an application or drivers that enable mobile computing device 10 to be configured as a USB audio device, such as a USB microphone, and to transmit audio stored on storage devices 66 over USB connection 6 to USB host 34, in accordance with one or more aspects of this disclosure. USB module 12 may include audio module 14 and power module 16. Audio module 14 may generally perform conversion (e.g., encoding or decoding) to and/or from any audio format supported by a USB audio device.

Audio module 14 may generally perform conversion (e.g., encoding or decoding) to and/or from any audio format supported by a USB audio device. In some examples, audio module 14 may comprise one or more hardware or software audio encoders or decoders, as well as inputs, outputs and feature units, as described below with respect to FIG. 3. Audio module 14 may support various audio formats, such as Pulse Channel Modulation (PCM), Motion Picture Experts Group (MPEG) Audio Layer 3 (MP3), or any of the standard USB Audio Format Types I-IV or the extended USB Audio Data Format Types as defined by the document titled “Universal Serial Bus Device Class Definition for Audio Data Formats, revision 2.0” (referred to as “USB Audio Formats Standard”) published May 31, 2006 by the USB Implementers Forum, and which is herein incorporated by reference in its entirety.

Communication unit 62 may also communicate over USB connection 6 with USB host computing devices, such as USB host 34. Communication unit 62 may also communicate with external devices via one or more networks, such as one or more wireless networks. Communication unit 62 may be a network interface card, such as an Ethernet card, an optical transceiver, a radio frequency transceiver, or any other type of device that can send and receive information. Other examples of such network interfaces may include Bluetooth®, 3G and WiFi® radios in mobile computing devices as well as USB™.

USB module 12 may send and receive data over a USB connection, e.g. USB connection 6 of FIG. 1. In particular, USB module 12 may make configure mobile computing device 10 as though mobile computing device is a USB microphone in accordance with one or more aspects of this disclosure. USB module 12 may also control the process of sending audio data over USB connection 6 using a USB-compatible transfer mechanism, such as an isochronous transfer mechanism, which is discussed in greater detail below.

Power module 16, which may comprise one or more current and/or voltage regulators and converters, as well as voltage transformers, may convert the power received from USB connection 6 into an appropriate voltage to power mobile computing device 10 and/or in the example where power source 4 comprises a rechargeable power source such as a battery, to charge power source 4.

NFC module 19 may detect the presence of NFC tag 35 (FIG. 1) of USB host 34. In some examples, NFC module 19 may detect NFC tag 35 over a short-range communication channel. In one example, the short-range wireless communication between NFC module 19 and NFC tag 35 may occur within a particular distance. Exemplary distances include 100 meters, 10 meters, 5 meters, 0.1 meters, and 0.02 meters. NFC module 19 may communicate, in one example, in a radio frequency band of 13.56 megahertz or similar, and may have a spectral envelope as wide as 1.8 megahertz.

NFC module 19 may detect NFC tag 35, in some examples, using an active or passive mode of operation. In an active mode of operation, NFC tag 35 may generate a first radio field that is received by mobile computing device 10 in physical proximity to NFC tag 35. In response, mobile computing device 10 may generate a second radio field that is received by NFC tag 35. In this way, data may be communicated between mobile computing device 10 and NFC tag 35, such as using peer-to-peer communication.

In a passive mode of operation, NFC tag 35 may employ load modulation techniques to facilitate data communication between mobile computing device 10 and NFC tag 35. In a passive mode, NFC tag 35 does not generate a radio field in response to the radio field of NFC module 19. Instead, NFC tag 35 may include electrical hardware that generates a change in impedance in response to a radio field. For example, NFC module 19 may generate a radio field that NFC tag 35 receives. Electrical hardware in NFC tag 35 may generate a change in impedance in response to the radio field, which may result in a change in a change in the radio field between NFC module 19 and NFC tag 35. NFC module 19 may detect the change in impedance. In this way, NFC tag 35 may use load modulation techniques to transmit information to NFC module 19.

Mobile computing device 10 may receive information in response to receiving a radio field from NFC tag 35. The Information may include a data payload that includes data stored and/or generated by USB host 34 or NFC tag 35. In some examples, the data payload may include information usable to configure mobile computing device 10 in as USB logical interface mode, such as a USB microphone interface. As an example, the payload may include information related to one or more audio formats that USB host 34 may support for receiving streaming of audio. In other examples, the data payload may also include a unique identifier 22. In one example, unique identifier 22 may include data, such as a serial number, or other data that uniquely identifies device USB host 34. Responsive to detecting the presence of NFC tag 35, NFC module 19 may output a stream of audio data based on the information related to the one or more audio formats to host 34 over USB connection 6 in accordance with the one or more aspects of this disclosure.

Mobile computing device 10, in one example, also includes one or more input devices 18. Examples of input devices 18 include a presence-sensitive screen, a mouse, a keyboard, a voice responsive system, video camera, microphone or any other type of device for detecting a command from a user. In some examples, a presence-sensitive screen includes a touch-sensitive screen.

One or more output devices 20 may also be included in mobile computing device 10. Output device 20, in some examples, is configured to provide output to a user using tactile, audio, or video stimuli. Output devices 20, in one example, include a presence-sensitive screen, a sound card, a video graphics adapter card, and/or any other type of device for converting a signal into an appropriate form understandable to humans or machines. Additional examples of output devices 20 include a speaker, a cathode ray tube (CRT) monitor, a liquid crystal display (LCD), or any other type of device that can generate intelligible output to a user.

Output devices 20 may include a display, which may output GUI 22 of FIG. 1. A user may utilize one or more of input devices 18 to select a graphical element 24 of GUI 22. Responsive to selecting graphical element 24, mobile computing device change the logical mode of mobile computing device 10 and may redirect audio from output devices 20 to USB module 12, and over USB connection 6 to host module 34 in accordance with one or more aspects of this disclosure.

Mobile computing device 10 may include operating system 72. Operating system 72, in some examples, controls the operation of components of mobile computing device 10. For example, operating system 72, in one example, facilitates the redirection of audio streams, e.g., MP3 audio or other audio stream of mobile computing device 10, to USB module 12, and from USB module 12 over USB connection 6. One or more of applications 74 may include program instructions and/or data that are executable by mobile computing device 10 in order to perform the aspects of this disclosure, such as selecting a logical audio interface device mode of mobile computing device 10 to stream audio to USB host 34. In an example, one of applications 74 may receive a selection of an audio format, and responsive to receiving the selection, mobile computing device 10 may output a digital audio data stream to USB host 34 over USB connection 6, in an audio format based on the selected audio format, for.

Mobile computing device may include power source 4. In some examples, power source 4 may comprise a battery, power adapter, transformer, wall plug, or any other power source capable of providing power to mobile computing device 10. Although illustrated as integrated with mobile computing device 10 with respect to FIG. 2, power source 4 may also be separate from mobile computing device 10.

Although FIG. 2 illustrates a conceptual diagram of mobile computing device 10, a USB host, such as USB host 34 may be comprised of similar components, such as a processor, input and output devices, storage devices, an operating system, applications, communication units, and a power source. USB host 34 may differ from mobile computing device 10 in that USB host 34 may have a power module 39, which transfers power from a power source 26 to mobile computing device 10 over USB connection 6. USB host 34 may also receive audio from mobile computing device 10 over USB connection 6, and include NFC tags 35.

FIG. 3 is a conceptual diagram illustrating an example of a USB microphone logical topology in accordance with one or more aspects of the present disclosure. The topology of FIG. 3 includes input terminal 100, pins 102A and 102B, feature unit 104, pins 106A and 106B, output terminal 108, and clock unit 110. Input terminal 100, feature unit 104, and output terminal 108 may not be physical devices. Rather, mobile computing device 10 may implement logical or virtual versions of the topology of FIG. 3. USB host 34 may control input terminal 100, feature unit 104, and output terminal 108 over USB connection 6.

Mobile computing device 10 may share information related to the configuration of the topology of FIG. 3 by transmitting, upon request, configuration information, referred to as descriptors, for each of input terminal 100, feature unit 104, output terminal 108, and clock unit 110. Mobile computing device 10 may expose the descriptors to implement a USB microphone interface capable of streaming stored audio of mobile computing device 10 to USB host 34 in accordance with one or more aspects of this disclosure.

In the topology of FIG. 3, input terminal 100 receives audio information. In a physical microphone, input terminal 100 may represent a transducer that converts sound waves to an electrical current. However, mobile computing device 10 may redirect audio stored on mobile computing device 10 through a USB microphone interface for streaming to USB host 34. Accordingly, mobile computing device 10 may implement a logical version (e.g., in software) of input terminal 100 that receives stored digital audio from mobile computing device 10, rather than receiving an analog audio signal. Accordingly, mobile computing device 10 may emulate the functionality of input terminal 100, but may not include a physical hardware transducer or other analog-to-digital convert (ADC).

In the topology of FIG. 3, input terminal 100 includes an output pin 102A. Output pin 102A may be connected to input pin 102B of feature unit 104. Because output pin 102A is connected with input pin 102B of feature unit 104, feature unit 104 may receive audio from input terminal 100. As with input terminal 100, output pin 102A, input pin 102B, and feature unit 104 may be logical rather than physical. Feature unit 104 may include controls, such as volume and/or muting controls that user 8 may use to control the audio stream received from input terminal 100. As an example, user 8 may utilize a volume control or mute button to raise, lower, or mute the volume of the audio streamed to USB host 34.

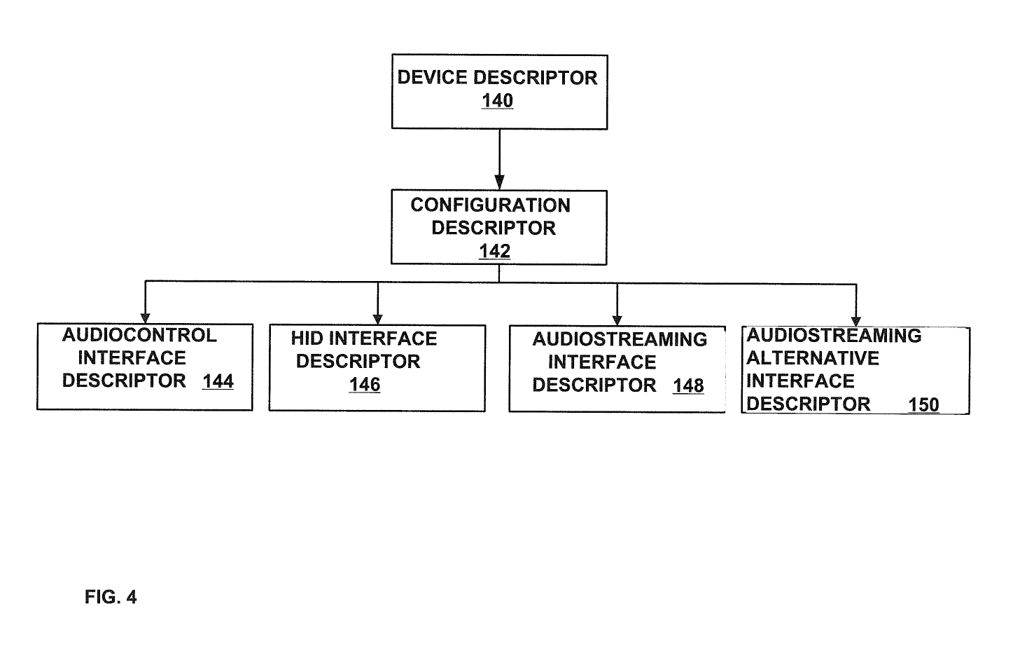

Feature unit 104 includes an output pin 106A, which is connected to input pin 106B of output terminal 108. Output terminal 108 represents an “AudioStreaming” interface that may transmit audio data stream(s) over USB connection 6. Details of the AudioStreaming interface are described with respect to FIGS. 4-7 below. Each AudioStreaming interface may support only one USB Audio Type as defined in the USB Audio Format Standard.

As described above, mobile computing device 10 may transmit descriptors to indicate information about the elements of the topology of FIG. 3. The descriptors that mobile computing device 10 transmits may also indicate the virtual connections between the elements of the topology of FIG. 3. As an example, the descriptors may indicate that input terminal 100 is connected to feature unit 104, and that feature unit 104 is connected to output terminal 108. USB host 34 may determine the interconnection of the elements of a topology from the descriptors.

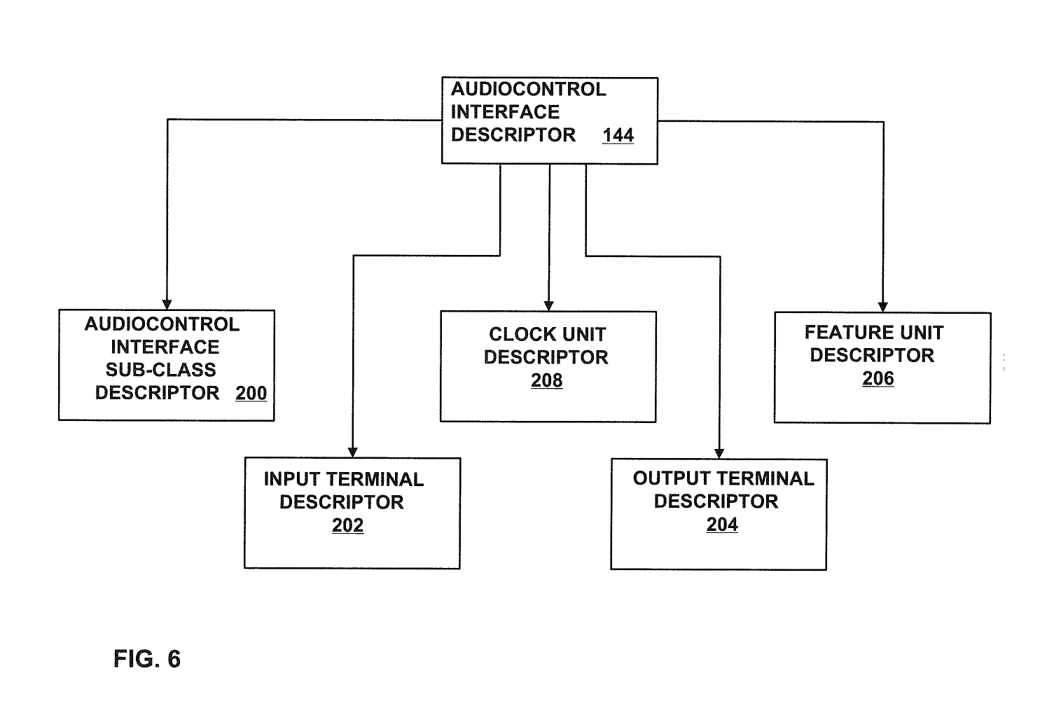

The topology of FIG. 3 also includes a clock unit 110. The clock unit may comprise a hardware or software clock that may be used to synchronize the operations of input terminal 100, feature unit 104, and output terminal 108. The clock unit is described in further detail with respect to FIG. 6, below.

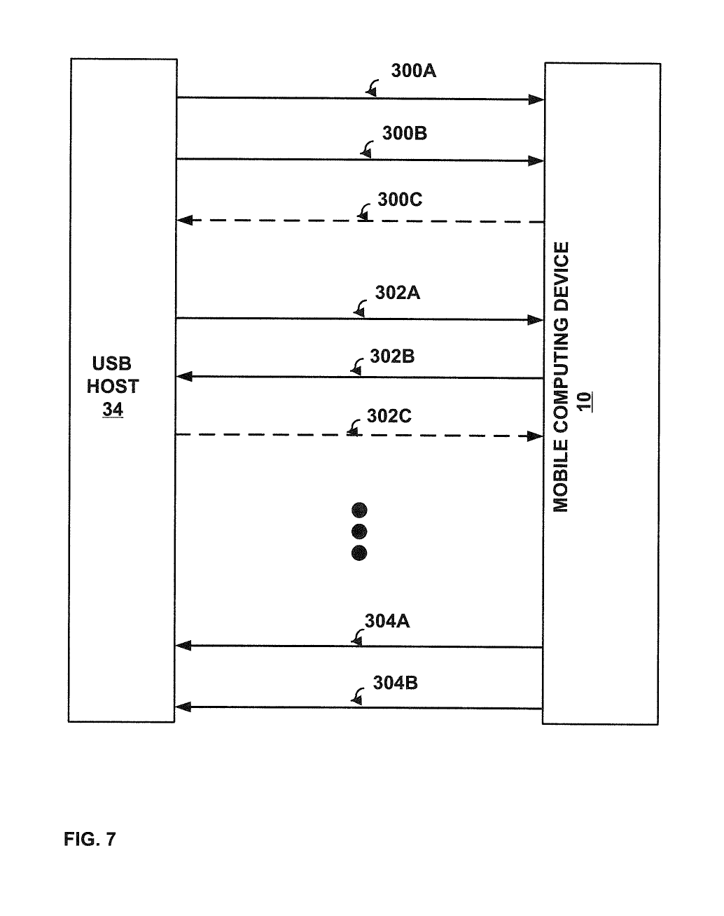

Mobile computing device 10 may also include multiple topologies similar to the topology illustrated in FIG. 3. In an example, the additional topologies may allow mobile computing device 10 to stream different types of audio formats to USB host 34. USB host 34 may select one of the multiple topologies to select a particular audio format for streaming. To enable USB host 34 to select from the multiple topologies, mobile computing device 10 may transmit a set of additional descriptors that correspond to each additional topology to USB host 34. USB host 34 may receive the additional sets of descriptors, and may signal a selection of one of the sets of topologies. Responsive to receiving the selection of the particular topology, mobile computing device 10 may activate the particular topology. The transmission of descriptors and selection of a particular topology is described below with respect to FIG. 7

FIG. 4 is a diagram illustrating a hierarchy of descriptors of a USB microphone interface in accordance with one or more aspects of the present disclosure. USB host 34 may monitor USB connection 6 and may detect a voltage change over USB connection 6 when mobile computing device 10 is connected to USB connection 6 and is configured to act as a USB microphone in accordance with one or more aspects of this disclosure. USB host 34 may then inquire about the capabilities of mobile computing device 10 in order to select a configuration and to enable communication between mobile computing device 10 and USB host 34. Details of the messaging process between USB host 34 and mobile computing device 10 is described below with respect to FIG. 7.

USB host 34 initially requests device descriptor 140 from mobile computing device 10. Each USB device may only have one device descriptor. Device descriptor 140 indicates a number of configurations included in mobile computing device 10. USB host 34 receives interprets device descriptor 140 and may then request configuration descriptor 142. Configuration descriptor 142 includes data fields that may indicate a number of interfaces that mobile computing device 10 supports. Although illustrated as having a single configuration descriptor, mobile computing device 10 may include multiple configuration descriptors similar to configuration descriptor 142.

USB host 34 may determine the number of interfaces associated with configuration 142 and request descriptors for each of the interfaces and any sub-interfaces that may be included with each interface from mobile computing device 10. In the example of FIG. 4, mobile computing device 10 may transmit an AudioControl interface descriptor 144, HID interface descriptor 146, AudioStreaming interface Descriptor 147, and an AudioStreaming alternative interface 150 to USB host 34.

AudioControl interface descriptor 144 may indicate information about an associated AudioControl interface. The AudioControl interface may include additional sub-descriptors or “class-specific descriptors.” The class-specific audio descriptors of AudioControl interface descriptor 144 may correspond to each element of the audio topology of mobile computing device 10, such as descriptors for input terminal 100, feature unit 104, and output terminal 108 of the topology illustrated in FIG. 3. The class-specific descriptors of AudioControl interface descriptor 144 are described in further detail below with respect to FIG. 6.

Configuration descriptor 142 may be associated with an HID (Human Interface Device) interface descriptor 146. HID interface descriptor 146 may be associated with an HID interface of mobile computing device 10. HID interface descriptor 146 may include information related to the functioning of various interactive features of the microphone interface of mobile computing device 10. As some examples, the HID interface descriptor 146 may include functional descriptions of the volume and/or muting controls of the microphone interface of mobile computing device 10.

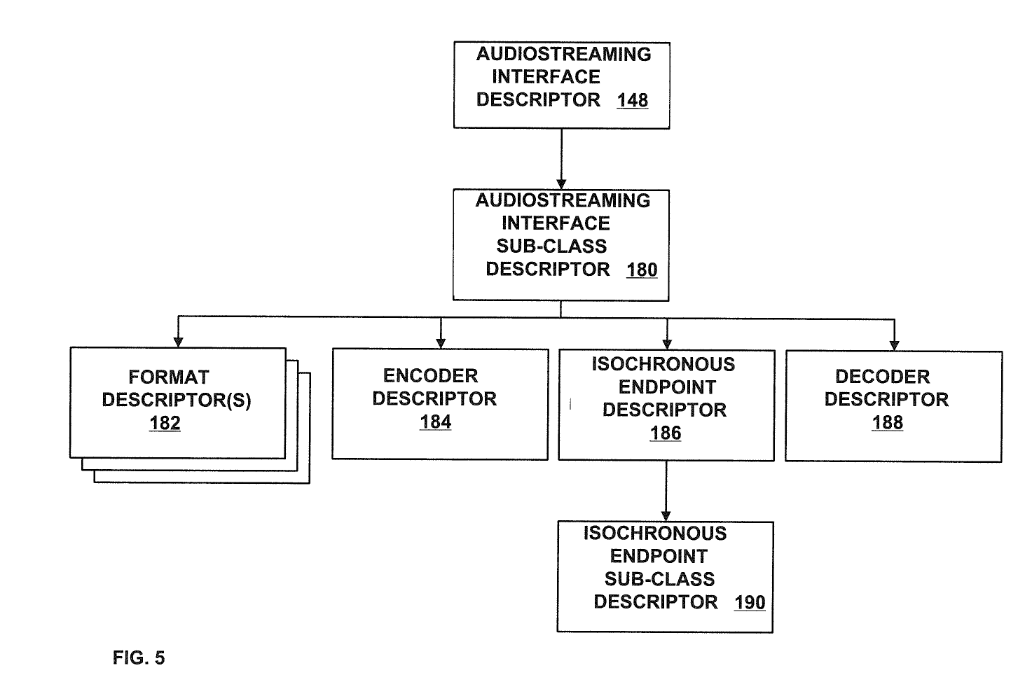

Configuration descriptor 142 may also be associated with AudioStreaming interface descriptor 148. AudioStreaming interface descriptor 148 and sub-descriptors of AudioStreaming interface 148 may include information related to the format of the audio stream that mobile computing device 10 transmits to USB host 34. An example illustration of the sub-descriptors of AudioStreaming interface descriptor 148 are illustrated in further detail with respect to FIG. 5, below.

Configuration descriptor 142 may also include one or more additional AudioStreaming alternative interface descriptors, each of which may be associated with an AudioStreaming alternative interface. Each additional AudioStreaming alternative interface may represent an alternative configuration that USB host 34 may select in order to stream audio stored on mobile computing device 10 to USB host 34.

FIG. 5 is a diagram illustrating a hierarchy of AudioStreaming interface sub-descriptors of a USB microphone interface in accordance with one or more aspects of the present disclosure. FIG. 5 illustrates AudioStreaming interface descriptor 148, which is also illustrated in FIG. 4. AudioStreaming interface descriptor 148 also includes AudioStreaming interface sub-class descriptor 180. AudioStreaming interface sub-class descriptor 180 may be further associated with additional sub-descriptors that may include one or more format descriptors 182, encoder descriptor 184, isochronous endpoint descriptor 186, and decoder descriptor 188. Isochronous endpoint descriptor 186 may also be associated with a sub-class descriptor, isochronous endpoint sub-class descriptor 190.

As stated above, AudioStreaming interface descriptor 148 and associated sub-descriptors may describe information related to the audio format used to stream information from mobile computing device 10 to USB host 34. In particular, AudioStreaming interface descriptor 148 may include a data field that indicates a particular audio “Format Type” that the AudioStreaming interface associated with AudioStreaming interface descriptor 148 supports for transmitting streaming audio.

AudioStreaming interface descriptor 148 may indicate that the associated AudioStreaming interface supports one audio Format Type, as defined by the USB Audio Formats Standard. The USB Audio Formats Standard defines four types of “standard audio types”: “Type I,” “Type II,” “Type III,” and “Type IV,” which a USB audio device may support. Type I audio generally comprises uncompressed audio, such as PCM audio or other uncompressed audio formats. The Type II audio format is a raw audio stream with an unspecified audio format. Type III audio generally includes compressed audio such as Motion Picture Experts Group (MPEG) audio, Windows Media Audio (WMA), AC-3, and DTS audio. Type IV audio includes audio that is not actually transmitted over a USB connection, but uses an AudioStreaming interface to control an audio encoder or decoder, such as a S/PDIF audio connection that is separate from USB connection 6. The USB Audio Data Formats Standard also defines three “Extended Type” audio formats, referred to as “Extended Types I-III,” which allow for more customized or application-specific audio formats. Each AudioStreaming interface may support any of the formats of Types I-IV, as well as any of the Extended formats I-III as defined by the USB Audio Data Formats Standard 2.0, which may also include one or more audio formats that are defined in the USB Audio Data Formats Standard 1.0.

Each AudioStreaming interface may support only one Audio Format Types I-III and Extended Types I-IV. However, mobile computing device 10 may include additional AudioStreaming interfaces, each of which may be configured such that the additional AudioStreaming interface supports additional audio Format Types, as defined in the USB Audio Data Formats Standard. As an example, AudioStreaming interface descriptor 148 may not indicate that a corresponding AudioStreaming interface supports both PCM (a Type I audio format), and MP3 (a Type III audio format), because PCM and MP3 belong to two different Standard Formats Types. However, mobile computing device 10 may include separate AudioStreaming interface descriptors, each of which may associated with a different AudioStreaming interface. One AudioStreaming interface may support a Type I audio format, such as PCM, and the other AudioStreaming interface may support a Type III audio format, such as MP3. In an example, mobile computing device 10 may include a default AudioStreaming interface (indicated by a descriptor), and one or more alternative AudioStreaming interfaces. USB host 34 may select between the default and alternative interfaces, each of which supports different audio formats, for example, based on an audio decoding capabilities of USB host 34.

AudioStreaming interface sub-class descriptor 148 may indicate one or more audio sub-formats that the AudioStreaming sub-class interface associated with AudioStreaming interface sub-class descriptor supports 180. AudioStreaming sub-class interface descriptor 180 may include a value (referred to as a “formats bitmap”) that indicates the one or more audio sub-formats that the AudioStreaming class-specific interface supports. The values of certain bits of the formats bitmap may indicate whether the AudioStreaming sub-class interface supports a particular audio sub-format. As an example, if the 0^{th} bit of the formats bitmap is equal to one, and the second bit is equal to one, the formats bitmap of the AudioStreaming sub-class interface may indicate that the AudioStreaming sub-class interface supports an 8-bit PCM audio format, as well as an IEEE floating point audio format.

As stated above, each AudioStreaming interface may only indicate that the corresponding AudioStreaming interface supports one of the Audio Types I-IV or Extended Types I-III, but each sub-class Audio Streaming interface may support multiple audio sub-formats. Based on the audio sub-formats that the AudioStreaming sub-class interface supports, mobile computing device 10 may include one or more audio decoder and/or encoder audio entities. Each encoder or decoder may also have an associated encoder or decoder descriptor. The encoder and decoder audio entities may comprise logical (as opposed to physical) interfaces that mobile computing device 10 may expose to USB host 34. USB host 34 may read from and/or write to the encoder(s) and/or decoder(s) in order to monitor and/or adjust the encoding or decoding process that is performed when streaming Type III audio formats to USB host 34. The encoders and/or decoders may include one or more of a WMA, MPEG, DTS, and/or AC-3 encoder and/or decoder.

As an example, if the AudioStreaming sub-class interface associated with AudioStreaming sub-class interface 180 is configured to stream MP3 audio output, AudioStreaming sub-class interface 180, encoder descriptor 184 may indicate that the AudioStreaming sub-class interface includes an MPEG encoder that receives audio stored on mobile computing device, and encodes the audio data into the MP3 format. In another example, AudioStreaming interface 180 may also include a decoder which is associated with decoder descriptor 188. As an example, the AudioStreaming interface may receive stored audio data in an encoded form, such as WMA, and the decoder associated with decoder descriptor 188 may decode the audio data for transmission in an uncompressed form, such as PCM, to USB host 34.

Each of audio encoder 184 and/or decoder descriptor 188 may include detailed information of the audio that is being encoded and/or decoded. As an example, lossy or compressed audio encoder or decoder descriptors, the encoder descriptor 184 and/or decoder descriptor 188 may include information related to parameters, such as the bitrate, profile (e.g., MPEG level or audio quality setting), support for dynamic range control, underflow, overflow, and error control of the encoded or decoded bitstream that results from the encoder or decoder. The full listing of audio parameters is described in the USB Audio 2.0 Standard.

In some examples the audio encoder and/or decoders associated with encoder descriptor 184 and/or decoder descriptor 188 may comprise a physical (e.g., hardware) device or a logical (e.g., software) device that performs the encoding or decoding in software. In an example, mobile computing device 10 may be configured according to the USB Audio 1.0 Standard, and mobile computing device 10 may not expose any encoder and/or decoder descriptors or interfaces or descriptors, because the USB Audio Device 1.0 standard does not require exposing encoder and/or decoder interfaces.

Mobile computing device 10 may also expose and transmit to USB host 34 one or more format descriptors 182, each of which may be associated with an audio format that the corresponding AudioStreaming interface supports. Each of format descriptors 182 may provide additional information about each audio sub-format that the AudioStreaming sub-class interface supports, and may correspond to one of the sub-formats indicated by the values of formats bitmap of AudioStreaming sub-class descriptor 180. In addition, each of format descriptors 182 may include information about the number of bytes occupied by an audio subslot, as well as the number effectively used bits from the available bits in an audio subslot. A more detailed description of format descriptors 182 may be found in the USB Audio Formats Standard.

AudioStreaming sub-class interface descriptor 180 may further include an isochronous endpoint descriptor 186, which may be associated with an isochronous endpoint interface. Isochronous endpoint descriptor 186 may further include an isochronous endpoint sub-class descriptor 190, which may also be associated with the isochronous endpoint interface. Isochronous endpoint descriptor 180 and isochronous endpoint sub-class class descriptor both describe the data flow between mobile computing device 10 and USB host 34 over an isochronous data connection.

Isochronous endpoint interfaces may support isochronous transfers, which may provide a guaranteed data rate of transmission over USB connection 6. Additionally, isochronous transfers may have low jitter or latency characteristics, which may be advantageous for transmitting audio applications that may be sensitive to these transmission characteristics. However, isochronous transfers may not provide synchronization capabilities. Isochronous endpoint descriptor 186 includes parameters that associate the descriptor with a particular endpoint, such as output terminal 108 (FIG. 3), as well as a maximum packet size that may be transmitted over the endpoint, and an endpoint polling interval for data transfers.

Isochronous endpoint sub-class descriptor 190 includes additional information that further describes the isochronous interface. In an example, the information may include whether the endpoint interface supports pitch control, data overrun control, data underrun control, and information related to the lock delay of the isochronous endpoint interface. Further detail about the format of isochronous endpoint descriptors and sub-class descriptors may be found in the USB Audio 2.0 Standard.

FIG. 6 is a diagram illustrating a hierarchy of AudioControl interface sub-descriptors of a USB microphone interface in accordance with one or more aspects of the present disclosure. AudioControl descriptor 144, also illustrated in FIG. 4, includes an AudioControl interface sub-class descriptor 200, input terminal descriptor 202, output terminal descriptor 204, feature unit descriptor 206, and clock unit descriptor 208. Each of the AudioControl sub-descriptors provides additional details about the features of the audio topology illustrated in FIG. 3.

AudioControl interface sub-class descriptor 200 may be a header, which includes the total length in bytes of all clock, source, and unit, and terminal descriptors, such as input terminal descriptor 202, output terminal descriptor 204, and feature unit descriptor 206. USB host 34 may utilize AudioControl interface sub-class descriptor 200 to request input terminal descriptor 202, output terminal descriptor 204, feature unit descriptor 206, and clock unit descriptor 208.

Input terminal descriptor 202 is associated with input terminal 100 (FIG. 3). Input terminal descriptor 202 may further indicate information about the number of audio channels of input terminal descriptor 202, as well as the location of those audio channels. Input terminal descriptor 202 may further include an associated terminal field that indicates to what terminal or feature unit the output of input terminal 100 is connected. In accordance with the example of FIG. 3, the value of the associated terminal indicates that the output of input terminal 100 may be connected to feature unit 104. Input terminal descriptor 202 may further include a control field that indicates whether input terminal 100 supports various protections for the audio output from input terminal, such as copy protections, overflow, and underflow control. Input terminal descriptor 202 may also include a source ID field, the value of which may indicate the identifier of clock unit 110, to which input terminal 100 may be connected.

Feature unit descriptor 206 may be associated with feature unit 106, and may include data fields that indicate information about the features that feature unit 106 supports. As an example, feature unit descriptor 206 may include a data field that indicates whether feature unit 106 supports features, such as volume control, muting, bass control, equalization, etc. A full list of features that feature unit 106 may support is listed in the USB Audio 2.0 Standard. Feature unit descriptor 206 may further include a source ID field, which, in the example of FIG. 3, may indicate the clock source 110 to which feature unit 106 is connected.

Output terminal descriptor 204 may be similar to input terminal descriptor 202. Output terminal descriptor 204 may include a data field that indicates that the input received by output terminal 108 is received from feature unit 106. Output terminal descriptor 106 may similarly include a source ID field, which indicates the clock source 110 to which output terminal 108 is attached.

Clock Unit descriptor 208 may indicate properties of clock unit 100 of FIG. 3. In particular, clock unit descriptor 208 may indicate properties, such as whether clock unit 1120 is an external, or internal clock, whether clock unit 110 is variable or programmable, and whether clock unit 110 supports a clock frequency control. In an example, mobile computing device 10 may indicate through clock unit descriptor 208 that clock unit 110 is an internal fixed or variable clock.

FIG. 7 is a conceptual diagram illustrating a series of USB transfers between a USB host and a USB device in accordance with one or more aspects of the present disclosure. In the example of FIG. 3, USB host 34 and mobile computing device 10 engage in a series of USB transfers over USB connection 6 of FIG. 1, which enable mobile computing device 10 to appear as a USB audio device, such as a USB microphone, and to transmit audio data streams stored on mobile computing device 10 through USB connection 6 to USB host 34.

As an example, USB host 34 may detect that mobile computing device 10 is connected to USB connection 6 based on a change in voltage over a USB cable, which may be associated with the connection of mobile computing device 10 to USB connection 6. In an example where mobile computing device 10 is already connected to USB host 34, but does not appear as a microphone, USB host 34 may detect that mobile computing device 10 has been re-configured responsive the USB configuration of mobile computing device changing to act as a USB microphone.

Once USB host 34 detects that mobile computing device 10 is connected over USB connection 6, or that mobile computing device 10 has been re-configured, USB host 34 may engage in a series of control transfers with mobile computing device 10. The control transfers request information about various descriptors of mobile computing device 10. In response to the requests from USB host 34 for the descriptors, mobile computing device 10 may reply to USB host 34 with the requested descriptors. The descriptors have been described above with respect to FIGS. 4-6, and may include information about the capabilities and configuration of various interfaces of a USB microphone. Once mobile computing device 10 has transferred the requested descriptors to USB host 34, mobile computing device 10 may receive commands from USB host 34, such as muting, and volume adjustment commands. Mobile computing device may also transfer streams of audio data stored on mobile computing device 10 to USB host 34 in accordance with one or more aspects of this disclosure, for example, using an isochronous data connection.

To inquire about the capabilities of USB host 34, mobile computing device requests information about the descriptors of USB host 34 using a series of control transfers, comprising messages 300A-300C. To begin the control transfer, USB host 34 constructs a setup token packet 300A and transmits the token packet 300A to mobile computing device 10. The token packet indicates that a subsequent device descriptor request packet 300B may follow setup packet 300A. Mobile computing device 10 receives the token packet and waits for a device descriptor request packet 300B. USB host 34 constructs and transmits device descriptor request packet 300B to mobile computing device 10. Device descriptor packet 300B requests information about a particular (in this example, default) endpoint of mobile computing device 10. An endpoint is a connection from a host (e.g., USB host 34) to a device (e.g., mobile computing device 10). Responsive to receiving packet 300B, mobile computing device 10 may decode or interpret the payload of packet 300C descriptor request, which includes the device descriptor request. Before responding with the requested device descriptor information, mobile computing device 10 constructs an acknowledgement (“ACK”) packet 300C, and transmits ACK packet 300C to USB host 34.

Responsive to decoding the received device descriptor request, mobile computing device 10 may initiate a second control transfer, comprising messages 302A-302C, with USB host 34. The packets of the second control transfer may include the device descriptor that USB host 34 had previously requested. To begin the second control transfer, USB host 34 constructs a USB IN token 302A. USB IN token 302A may indicate that mobile computing device 10 has permission to transmit a data packet containing the requested to device descriptor to USB host 34. Mobile computing device may then construct the data packet 302B, the payload of which includes the device descriptor that USB host 34 requested. Mobile computing device 10 may then transmit data packet 302B to USB host 34. Responsive to receiving data packet 302B, USB host 34 may construct an ACK packet 302C (ACK packets are indicated by a dashed line), which may acknowledge the receipt of data packet 302B, and may transmit ACK packet 302C to mobile computing device 10. In some examples, the size of the payload of the descriptor may greater than a maximum packet size. In this example, mobile computing device 10 to construct and send one or more additional data packets, each of which USB host 34 may precede with an additional IN token packet, and which mobile computing device 10 may acknowledge with an additional ACK packet. Thus, USB host 34 and mobile computing device 10 may construct and transmit additional packets in a manner that is similar or identical to that of messages 302A-302C.

If USB host 34 successfully receives all the packets which contain device descriptor data from mobile computing device 10, USB host 34 may construct an OUT token and transmit the OUT token to mobile computing device 10. USB host 34 may then construct a zero length data packet to acknowledge that USB host 34 has received the device descriptor. USB host 34 may then transmit the zero length data packet to mobile computing device 10. Responsive to receiving the zero length data packet, mobile computing device 10 may construct an ACK packet that acknowledges that the transaction of transmitting and receiving the device descriptor has completed successfully. The sequence of transmitting the OUT token, the zero length data packet, and the ACK packet may be identical to that of messages 300A-300C in that the IN token packet may be transmitted first, followed by the zero length data packet, which may then be followed by the ACK packet. However, the payload of the packets may differ.

The device descriptor (e.g., device descriptor 140 of FIG. 4) may include high-level information comprising about the USB interfaces that mobile computing device 10 may implement. Some of the fields of device descriptor 140 may indicate, a number of additional descriptors sub-descriptors, such as configuration descriptor 142 (FIG. 4). USB host 34 may determine the number of configuration descriptors of mobile computing device 10 from a value a configuration number field of device descriptor 140. USB host 34 may then request each configuration descriptor, such as configuration descriptor 142, by sending and receiving a sequence of messages similar to messages 300A-300C and 302A-302C of FIG. 7.

Configuration descriptor 142 may include one or more subordinate descriptors, such as AudioControl interface descriptor 144, HID interface descriptor 146, AudioStreaming interface descriptor 148, and one or more AudioStreaming alternative interface descriptors 150, as well format descriptors 182, and other descriptors described above with respect to FIGS. 4-6. Configuration descriptor 142 may include an additional value, which indicates the total size of all of the subordinate descriptors. Based on this size value of the configuration descriptor, USB host 34 may request that mobile computing device 10 transmit the one or more subordinate descriptors, such as AudioControl interface descriptor 144, HID interface descriptor 146, AudioStreaming interface descriptor 148, and one or more AudioStreaming alternative interface descriptors 150 to USB host 34, in this example. Mobile computing device 10 may transmit AudioControl interface descriptor 144, HID interface descriptor 146, AudioStreaming interface descriptor 148, and one or more AudioStreaming alternative interface descriptors 150 in a manner similar to that described above with respect to packets 300A-300C, and 302A-302C. The descriptors that mobile computing device 10 transmits to USB host 34 may be similar to those described with respect to FIGS. 4-6.

As described above, AudioControl interface descriptor 144, HID interface descriptor 146, AudioStreaming interface descriptor 148, and one or more AudioStreaming alternative interface descriptors 150 may include additional configuration information about the capabilities of interfaces of the USB microphone that supports streaming of audio stored on mobile computing device 10 to USB host 34 in accordance with one or more aspects of this disclosure.

Once USB host 34 receives all of the subordinate descriptors of device descriptor 140, which may include all the descriptors illustrated in FIGS. 4-6, USB host 34 may determine a configuration for mobile computing device 10. Once USB host 34 has determined a configuration for mobile computing device 10, USB host 34 may establish an isochronous data connection with an isochronous endpoint interface, which may correspond to output terminal 108 of mobile computing device 10. Once the isochronous connection has been established, mobile computing device 10 may stream audio data stored on mobile computing device 10 to USB host 34 using isochronous data transfers. The format of the audio transmitted (e.g., MP3, PCM, etc.) may correspond to an AudioStreaming interface configuration chosen by USB host 34. As an example, USB host 34 may select a configuration corresponding to the AudioStreaming interface associated with AudioStreaming interface descriptor 148, because that particular AudioStreaming interface may support MP3 audio transmission, and USB host 34 may be capable of decoding MP3 audio.

Mobile computing device 10 may also perform audio processing corresponding to one or more of the features that feature unit 106 supports. As an example, mobile computing device may receive an input form user 8 (FIG. 1) corresponding to a volume adjustment or muting command. Feature unit 106 may receive the input and manipulate the audio stream in accordance with the input. After feature unit 106 has input and manipulated the audio stream, output terminal 108 may output the audio stream to USB host 34 over USB connection 6.

Once USB host 34 has determined a configuration for mobile computing device 10, mobile computing device 10 may stream digital audio stored on mobile computing device 10 to USB host 34 over USB connection 6 using one or more isochronous transfers. Packets 304A-304C may comprise a series of messages of an isochronous transfer of audio data from mobile computing device 10 to USB host 34. To begin the isochronous transfer, mobile computing device 10 constructs an OUT token 304A and transmits the IN token to USB host 34 over the logical isochronous endpoint of USB connection 6. USB host 34 may receive the IN token packet, which may indicate to USB host 34 that an isochronous transfer from mobile computing device to USB host 34 is to follow. Mobile computing device 10 may then transmit one or more data packets, such as data packet 304B that contain streaming digital audio data, which is redirected from stored audio on mobile computing device 10. USB host 34 may receive the audio, decode, and output the audio using speakers 40 (FIG. 1) or another audio output device.

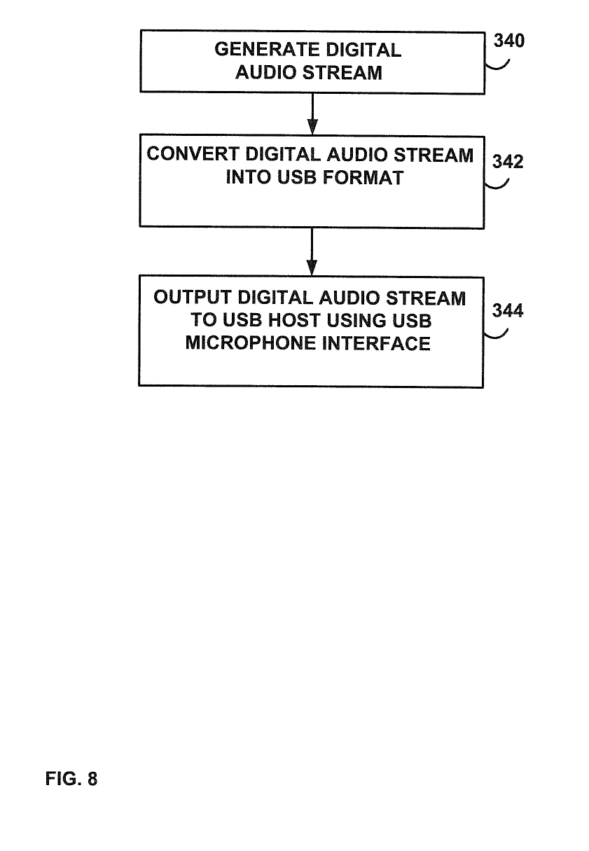

FIG. 8 is a flowchart illustrating an example process of transmitting audio to, and receiving power from a mobile computing device in accordance with one or more aspects of the present disclosure. For the purpose of example, the techniques of the process of FIG. 8 are described with respect to mobile computing device 10 of FIG. 1, however any computing device may perform the techniques described with respect to FIG. 8.

In the process illustrated in FIG. 8, mobile computing device 10 may generate a digital audio data stream based on audio data stored at the computing device (340). Mobile computing device 10 may be connected to USB host 34 over USB connection 6. In some examples, mobile computing device 10 may include at least one isochronous endpoint over which mobile computing device 10 may transmit the digital audio stream to USB host 34.

Mobile computing device may convert the digital audio stream into an audio format compatible with output by a Universal Serial Bus (USB) interface (342), for example PCM, WMA, or MP3. Mobile computing device 10 may generally convert the audio format into one of the audio formats described in the USB Audio Formats Standard. More particularly, the audio formats may include at least one of the USB Audio Data Format Type I, II, and III.

Mobile computing device 10 may receive a selection, for example, from user 8 of a logical audio interface device mode, such as a USB microphone device mode. In an example, to receive the selection, mobile computing device 10 may execute an application, and responsive to executing the application, may receive the selection of the logical audio interface. Mobile computing device 10 may also receive a selection of an audio format, for example, from one of applications 74 (FIG. 2). Responsive to receiving the selection of the audio format, mobile computing device 10 may output the digital audio data stream to USB host 34 using the microphone interface in an audio format based on the selected audio format.

When mobile computing device 10 is configured as a USB microphone device or other USB audio device, mobile computing device 10 may output the digital audio data stream to USB host 34 using an interface, such as the AudioStreaming interface, as illustrated in FIG. 3 (344). As another example, the AudioStreaming interface may be associated with AudioStreaming interface descriptor 148 illustrated in FIGS. 4-5. Mobile computing device 10 may include a plurality of configurations, such as AudioStreaming interfaces. Each configuration or interface may support a different set of audio formats. Mobile computing device 10 may receive a selection of one of the AudioStreaming configurations from USB host 34. Responsive to receiving the selection of the one of the plurality of configurations, mobile computing device 10 may enable the selected on of the plurality of configurations.

In some examples, mobile computing device 10 may be a mobile phone, such as a so-called “smartphone,” and USB host 34 may be a head unit, such as a CD player, stereo, navigation system, etc. of a vehicle. When entering an area, such as the cabin of a vehicle, user 8 of FIG. 1 may bring mobile computing device 10 in proximity with an NFC tag. Responsive to reading the NFC tag, mobile computing device 10 may select the logical audio interface mode of the computing device, which may correspond to a USB microphone interface mode of mobile computing device 10. Mobile computing device 10 may also receive information related to a USB audio format from the NFC tag. In response to receiving the information related to the USB audio format, mobile computing device 10 may configure the digital audio data stream based on the information related to the USB audio format.

Mobile computing device 10 may also detect a user input indicating an audio volume adjustment. Responsive to receiving the user input, mobile computing device 10 may adjust the audio data stream based on the user input, for example, by increasing, decreasing the volume of the audio data stream, or by muting the volume of the audio data stream.

When mobile computing device 10 is connected to USB host 34, mobile computing device 10 may receive power over USB connection 6. In some examples, mobile computing device may comprise a so-called “lower power device,” “high power device,” or a USB 3.0 device, which may receive up to 100 W of power over USB connection 6.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more aspects of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, of a computing system to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. Additional examples of computer readable medium include computer-readable storage devices, computer-readable memory, and tangible computer-readable medium. In some examples, an article of manufacture may comprise one or more computer-readable storage media.

In some examples, computer-readable storage media may comprise non-transitory media. The term “non-transitory” may indicate that the storage medium is tangible and is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method, comprising:
generating, by a computing device, a digital audio data stream based on audio data stored at the computing device;
converting, by the computing device, the digital audio stream into an audio format compatible with output by a Universal Serial Bus interface; and
outputting, by the computing device, the digital audio data stream to a Universal Serial Bus host using a Universal Serial Bus microphone interface, wherein the computing device and the Universal Serial Bus host are coupled by a Universal Serial Bus connection.

2. The method of claim 1, further comprising:
receiving, by the computing device, power using the Universal Serial Bus connection.

3. The method of claim 1, further comprising:
receiving, by the computing device, a selection of a logical audio interface device mode of the computing device.

4. The method of claim 1, further comprising:
wherein receiving the selection of the logical audio device interface comprises:
executing, by the computing device, an application of the computing device; and
responsive to executing an application of the computing device, receiving, by the mobile computing device, the selection of the logical audio device interface.

5. The method of claim 1, further comprising:
receiving, by the computing device, a selection of an audio format,
wherein outputting the digital audio data stream to the Universal Serial Bus host comprises:
responsive to receiving the selection of the audio format, outputting, by the computing device, the digital audio data stream in an audio format based on the selected audio format to the Universal Serial Bus host using the microphone interface.

6. The method of claim 1, further comprising:
reading, by the computing device, a Near Field Communication tag; and
responsive to reading the Near Field Communication tag, selecting, by the computing device, a logical audio interface device mode of the computing device.

7. The method of claim 6, further comprising:
receiving, by the computing device, information related to a Universal Serial Bus audio format from the Near Field Communication tag; and
responsive to receiving the information related to the Universal Serial Bus audio format, configuring, by the computing device, the digital audio data stream based on the information related to the Universal Serial Bus audio format.

8. The method of claim 1, wherein converting the digital audio stream into an audio format compatible with output by a Universal Serial Bus interface comprises converting, with the computing device, the digital audio stream in at least one of a Type I Universal Serial Bus Audio Data Format, a Type II Universal Serial Bus Audio Data Format, and a Type III Universal Serial Bus Audio Data Format.

9. The method of claim 1, wherein the Universal Serial Bus interface includes at least one isochronous endpoint.

10. The method of claim 1, further comprising:
configuring, with the computing device, the computing device to include a plurality of configurations, wherein each configuration of the plurality of configurations supports a different set of audio formats.

11. The method of claim 10, further comprising:
receiving, by the computing device, a selection of a configuration from the plurality of configurations from the Universal Serial Bus host; and
responsive to receiving the selection of the configuration, configuring, by the computing device, the computing device in accordance with the configuration.

12. The method of claim 1, further comprising:
detecting, by the computing device, a user input indicating an audio volume adjustment; and
responsive to receiving the user input, adjusting, by the computing device, the audio data stream based on the user input.

13. The method of claim 1, wherein the computing device is a mobile phone.

14. The method of claim 1, wherein the Universal Serial Bus host is a head unit of a vehicle.

15. A computer-readable storage medium encoded with instructions that, when executed, cause at least one processor of a computing device to:
generate a digital audio data stream based on audio data stored at a computing device;
convert the digital audio stream into an audio format compatible with output by a Universal Serial Bus interface; and
output the digital audio data stream to a Universal Serial Bus host using a Universal Serial Bus microphone interface, wherein the computing device and the Universal Serial Bus host are coupled by a Universal Serial Bus connection.

16. The computer-readable storage medium of claim 15, further comprising instructions that cause the at least one processor to:
receive a selection of a logical audio interface device mode of the computing device.

17. The computer-readable storage medium of claim 15, further comprising instructions that cause the at least one processor to receive power using the Universal Serial Bus connection.

18. A device comprising:
at least one processor;
a Universal Serial Bus interface; and
an audio module operable by the at least one processor to generate a digital audio data stream based on audio data stored at the device, convert the digital audio stream into an audio format compatible with output by the Universal Serial Bus interface, and output the digital audio data stream to a Universal Serial Bus host using a Universal Serial Bus microphone interface, wherein the device and the Universal Serial Bus host are coupled by a Universal Serial Bus connection.

19. The device of claim 18, wherein the device is further configured to receive a selection of a logical audio interface device mode of the device.

20. The device of claim 18, wherein the device further comprises:
a power module operable by the at least one processor to receive power using the Universal Serial Bus microphone connection.
